(19) United States
(12) Patent Application Publication
(10) Pub. No.: US 2025/0147386 A1
(43) Pub. Date: May 8, 2025

(54) REFLECTIVE MODULE AND CAMERA MODULE INCLUDING THE SAME

(71) Applicant: SAMSUNG ELECTRO-MECHANICS CO., LTD., Suwon-si (KR)

(72) Inventors: Young Hwan KWON, Suwon-si (KR); Do Seop HWANG, Suwon-si (KR); Bo Sung SEO, Suwon-si (KR); Young Bok YOON, Suwon-si (KR); Byung Woo KANG, Suwon-si (KR)

(73) Assignee: SAMSUNG ELECTRO-MECHANICS CO., LTD., Suwon-si (KR)

(21) Appl. No.: 18/917,983

(22) Filed: Oct. 16, 2024

(30) Foreign Application Priority Data
Nov. 3, 2023 (KR) 10-2023-0151180
Mar. 20, 2024 (KR) 10-2024-0038725

(51) Int. Cl. G03B 5/00; G02B 27/64

(52) U.S. Cl. CPC G03B 5/00; G02B 27/646; G03B 2205/0069

(57) ABSTRACT

A reflective module includes a first lens module having a first optical axis; a holder on which a reflective member is disposed to reflect light passing through the first lens module; a guide member on which the holder is disposed; a housing accommodating the holder and the guide member; and a first ball member, disposed between the guide member and the housing, comprising a first ball group and a second ball group, spaced apart in a direction of a first rotation axis. The first lens module and the holder are configured to rotate together about the first rotation axis and a second rotation axis, perpendicular to each other and perpendicular to the first optical axis. The guide member is configured to rotate about the first rotation axis, together with the first lens module and the holder.

### CROSS-REFERENCE TO RELATED APPLICATIONS

This application claims the benefit under 35 USC 119(a) of Korean Patent Application No. 10-2023-0151180, filed on Nov. 3, 2023, and Korean Patent Application No. 10-2024-0038725, filed on Mar. 20, 2024, in the Korean Intellectual Property Office, the entire disclosures of which are incorporated herein by reference for all purposes.

### BACKGROUND

### 1. Field

The following description relates to a reflective module and a camera module comprising the same.

### 2. Description of the Background

Camera modules may include a reflective member that bends the incident light path on a lens module. This type of camera module may have limitations in increasing the diameter of the lens because the diameter of the lens provided in the lens module affects the thickness of the mobile device. Therefore, there may be a problem in that it may be difficult to reduce the F-number of the camera module.

Accordingly, a structure in which some lenses are disposed in front of the reflective member has been proposed.

Meanwhile, the camera module has a shake correction function that corrects shake during shooting to increase resolution. This shake compensation function may be implemented through two-axis rotation of the reflective member. In this case, two-axis rotation may implemented through pitch rotation and yaw-wise rotation. Here, when a lens is disposed in front of the reflective member, the lens may be rotated together with the reflective member.

Here, the pitch rotation axis and the yaw-wise rotation axis mean two axes perpendicular to an optical axes of the lenses disposed behind the reflective member and perpendicular to each other.

For example, rotation based on the Yaw axis may be implemented by rotating the reflective member using a direction in which light is incident on the reflective member as the rotation axis, and rotation based on the Pitch axis may be implemented by rotating the Yaw axis and the lenses disposed behind the reflective member. It may be implemented by rotating the reflecting member using an axis perpendicular to the optical axis as the rotation axis.

Here, when the reflective member rotates yaw-wise, an error may occur in the change in an intended optical path length.

The reason is that in the case of yaw-wise rotation among two-axis rotation, the apparent positional change of the lens disposed in front of the reflective member before and after yaw-wise rotation may not be significant.

Therefore, when correcting shaking in the yaw direction, there may be a problem that a large aberration may occur, and resolution may deteriorate.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a reflective module includes a first lens module having a first optical axis; a holder on which a reflective member is disposed to reflect light passing through the first lens module; a guide member on which the holder is disposed; a housing accommodating the holder and the guide member; and a first ball member, disposed between the guide member and the housing, including a first ball group and a second ball group, spaced apart in a direction of a first rotation axis. The first lens module and the holder are configured to rotate together about the first rotation axis and a second rotation axis, perpendicular to each other and perpendicular to the first optical axis. The guide member is configured to rotate about the first rotation axis, together with the first lens module and the holder. The first ball group includes a plurality of balls arranged in a direction of the second rotation axis.

A first guide groove and a second guide groove may be disposed on surfaces on which the guide member and the housing face each other in a direction of the first optical axis. The first ball group may be disposed in the first guide groove, and the second ball group may be disposed in the second guide groove. Each of the first guide groove and the second guide groove may have a curved profile.

Each of the first guide groove and the second guide groove may have a rolling channel for the first ball group or the second ball group. A radius of curvature of the rolling channel may be equal to a distance in the direction of the first optical axis between the first rotation axis and the rolling channel.

Among a plurality of balls in the first ball group, two balls disposed outermost in the direction of the second rotation axis may have a larger diameter than a ball disposed therebetween.

The two balls may be in two-point contact with the guide member, and may be in two-point contact with the housing.

The second ball group may include a fewer number of balls than the plurality of balls included in the first ball group.

A diameter of an intermediate ball of the first ball group may be smaller than diameters of other balls of the first ball group.

A first pulling magnet may be disposed on one of the guide member or the housing, and a first pulling yoke is disposed on another thereof. The first pulling magnet and the first pulling yoke may face each other in the direction of the first optical axis. The first pulling magnet may be disposed between the first ball group and the second ball group.

The reflective module may further include a first driving unit including a first magnet disposed on the guide member, and a first coil disposed to face the first magnet. The first magnet and the first coil may face each other in the direction of the first rotation axis. One surface of the first magnet facing the first coil may have an N-pole, a neutral region, and an S-pole along the first optical axis.

A virtual line extending the first rotation axis may pass through the one surface of the first magnet.

The first coil may include two coils spaced apart in the direction of the second rotation axis.

The reflective module may further include a second ball member disposed between the holder and the guide member. The second ball member may include a plurality of balls spaced apart in the direction of the second rotation axis.

A second pulling magnet may be disposed on one of the holder or the guide member, and a second pulling yoke may be disposed on another thereof. The second pulling magnet and the second pulling yoke may face each other in the direction of the first optical axis. The second pulling magnet may be disposed between the plurality of balls of the second ball member.

The reflective module may further include a second driving unit including a second magnet disposed in the holder and a second coil disposed to face the second magnet. One surface of the second magnet facing the second coil may have an N-pole, a neutral region, and an S-pole along the first optical axis. The second driving unit may be disposed to be spaced apart from the second ball member in a direction of the first rotation axis.

In another general aspect, a camera module includes a guide member disposed in a housing to rotate about a first rotation axis; a holder disposed on the guide member to rotate relative to the guide member, based on a second rotation axis, perpendicular to the first rotation axis, and having a reflective member; a first ball member, disposed between the guide member and the housing, including a plurality of balls arranged to roll in a direction of the second rotation axis; a first lens module mounted on the holder and having a first optical axis, perpendicular to both the first and second rotation axes; and a second lens module into which light reflected from the reflective member is incident.

A guide groove may be disposed on surfaces on which the guide member and the housing face each other in a direction of the first optical axis. The guide groove may have a curved profile around the first rotation axis.

The camera module may further include a first driving unit including a first magnet disposed on the guide member, and a first coil disposed to face the first magnet in a direction of the first rotation axis; a second driving unit including a second magnet disposed in the holder and a second coil disposed to face the second magnet; and a second ball member, disposed between the holder and the guide member, including a plurality of balls spaced apart in the direction of the second rotation axis.

The second driving unit may be disposed between the first driving unit and the second ball member in the direction of the first rotation axis. The second driving unit may include two magnets spaced apart in the direction of the second rotation axis and two coils spaced apart in the direction of the second rotation axis, and the first ball member may be disposed between the two magnets.

Other features and aspects will be apparent from the following detailed description, the drawings, and the claims.

### BRIEF DESCRIPTION OF DRAWINGS

FIG. 1 is a perspective view of a camera module according to an embodiment of the present disclosure.

FIG. 2 is an exploded perspective view of a camera module according to an embodiment of the present disclosure.

FIG. 3 is an exploded perspective view of a reflective module according to an embodiment of the present disclosure.

FIG. 4 is a perspective view of a reflective module according to an embodiment of the present disclosure.

FIG. 5 is a view of FIG. 3 viewed in another direction.

FIG. 6 is a view of FIG. 4 viewed in another direction.

FIG. 7 is a diagram illustrating a first ball member disposed in a housing.

FIG. 8 is a diagram illustrating how a reflective module is rotated with a second optical axis as a rotation axis.

FIG. 9 is a diagram illustrating a holder being rotated using a first axis as a rotation axis.

FIG. 10 is a perspective view illustrating a second lens module separated from a camera module according to an embodiment.

FIG. 11 is a bottom perspective view of the second lens module.

FIG. 12 is a diagram illustrating a first stopper and a second stopper being coupled to the housing.

FIG. 13 is an exploded perspective view of a camera module according to another embodiment.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

The present disclosure relates to a camera module, and the camera module may be mounted on portable electronic devices such as mobile communication terminals, smart phones, or tablet PCs.

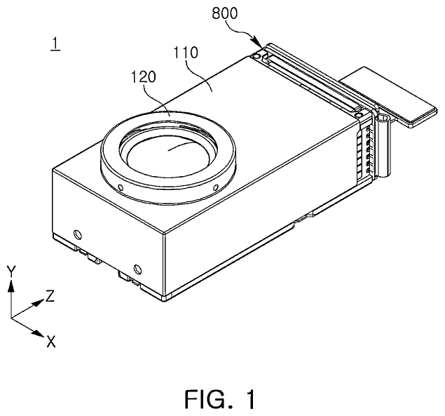

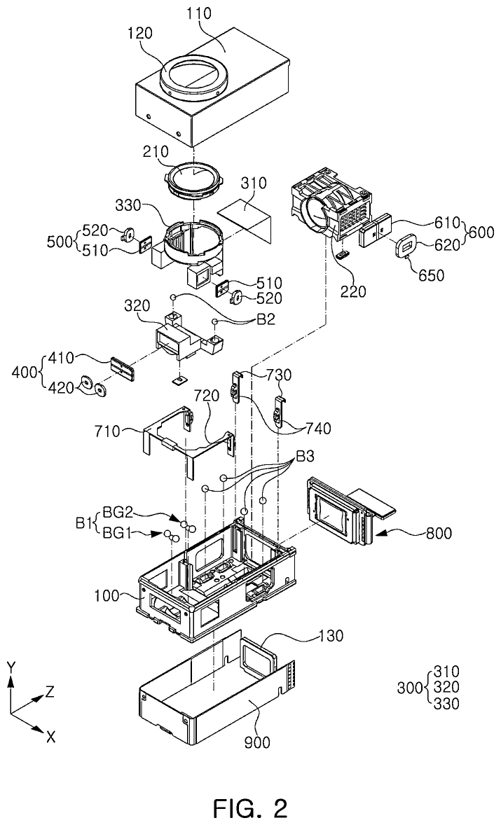

FIG. 1 is a perspective view of a camera module. FIG. 2 is an exploded perspective view of a camera module, according to an embodiment of the present disclosure.

Referring to FIGS. 1 and 2, a camera module 1 may include a first lens module 210, a reflective module 300, and a housing 100.

The first lens module 210 includes at least one lens that may have a first optical axis (Y-axis). The first optical axis (Y-axis) may extend in the vertical direction with respect to FIGS. 1 and 2.

The first lens module 210 may be disposed in front of the reflective module 300. Here, ‘in front’ may mean the positive first optical axis (Y-axis) direction (+Y-axis direction) with respect to the reflective module 300. For example, the first lens module 210 may be disposed higher than the reflective module 300 in the direction of the first optical axis (Y-axis).

The first lens module 210 and the reflective module 300 are disposed in the housing 100.

In an embodiment, the camera module 1 may further include a second lens module 220. The reflective module 300 is disposed between the first lens module 210 and the second lens module 220. The second lens module 220 includes a plurality of lenses, which are arranged along a second optical axis (Z-axis).

The first optical axis (Y-axis) of the first lens module 210 and the second optical axis (Z-axis) of the second lens module 220 may be formed perpendicular to each other.

The first lens module 210 includes one or more lenses, and the second lens module 220 includes a plurality of lenses.

One or more lenses of the first lens module 210 may be circular when viewed in the first optical axis (Y-axis) direction. At least one lens among the plurality lenses of the second lens module 220 may be non-circular when viewed in the second optical axis (Z-axis) direction. For example, a non-circular lens may have different lengths in two directions perpendicular to the second optical axis (Z-axis) and perpendicular to each other. In an embodiment, the non-circular lens may have a length in the first axis (X-axis) direction perpendicular to both the first optical axis (Y-axis) direction and the second optical axis (Z-axis) direction is longer than the length in the direction.

The first lens module 210 and the reflective module 300 may be configured to rotate together for shake correction. The second lens module 220 may be moved in the second optical axis (Z-axis) direction for focus adjustment.

The camera module 1 may further include an image sensor module 800.

The image sensor module 800 includes a sensor housing 830, an image sensor 810, a printed circuit board 820, and may further include an infrared blocking filter.

The infrared blocking filter may be mounted on the sensor housing 830. The infrared blocking filter blocks light in the infrared region among the light that has passed through the second lens module 220.

The printed circuit board 820 is coupled to the sensor housing 830, and the image sensor 810 is disposed on the printed circuit board 820.

Light passing through the second lens module 220 is received by the image sensor module 800 (e.g., image sensor 810).

The camera module 1 may further include a light-blocking plate 130. The light-blocking plate 130 is disposed in the housing 100 and serves to prevent a flare phenomenon from occurring due to unintentional reflection of light inside the housing 100.

The light-blocking plate 130 may be disposed in the space between the second lens module 220 and the image sensor module 800. Additionally, the light-blocking plate 130 may be disposed closer to the image sensor module 800 than the second lens module 220.

Therefore, even if unintentional reflection of light occurs inside the housing 100, the light diffusely reflected by the light-blocking plate 130 can be prevented from entering the image sensor 810. Thus, the flare phenomenon may be suppressed.

The camera module 1 may further include a case 110. Case 110 is coupled to housing 100 to cover the upper part of housing 100. Case 110 has an opening through which light enters. Light incident through the opening of the case 110 is incident on the first lens module 210.

Meanwhile, at least a portion of the first lens module 210 may be disposed to protrude outside the housing 100. In addition, the case 110 may further include a cover 120 covering the first lens module 210. The opening of the case 110 may be formed in the cover 120.

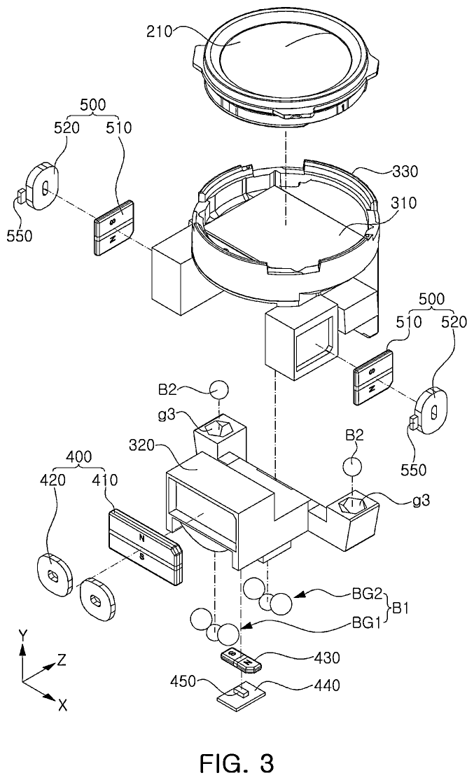

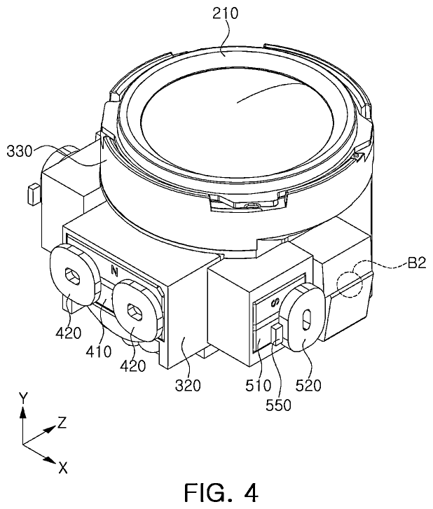

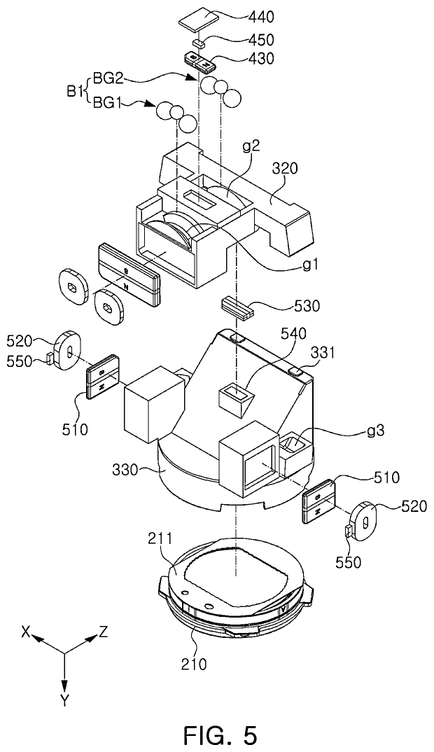

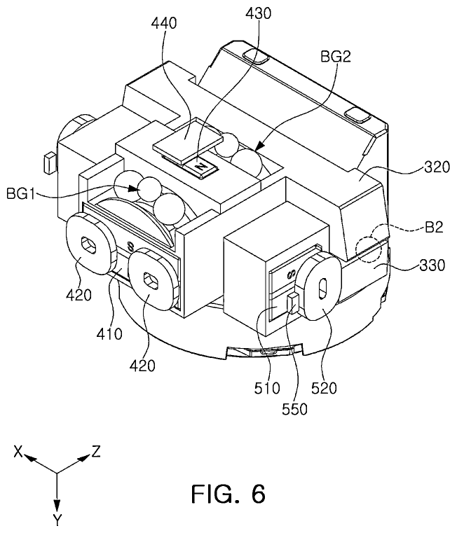

FIG. 3 is an exploded perspective view of a reflective module according to an embodiment of the present disclosure. FIG. 4 is a perspective view of a reflective module according to an embodiment of the present disclosure. FIG. 5 is a view of FIG. 3 viewed in a different direction, and FIG. 6 is a view of FIG. 4 viewed in a different direction.

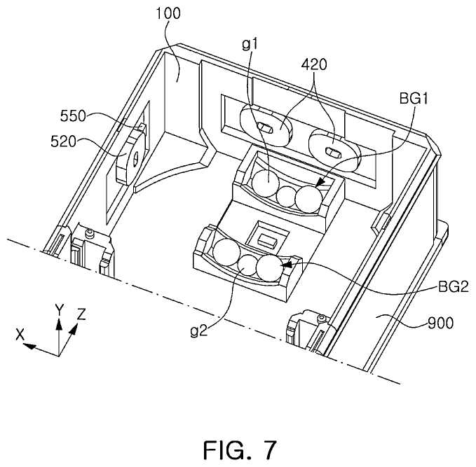

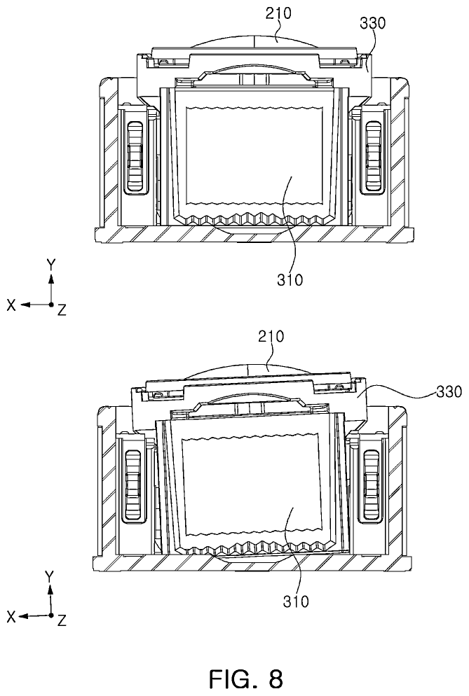

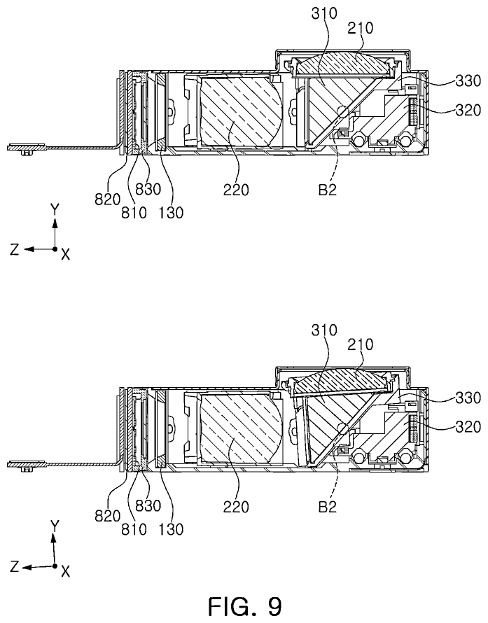

FIG. 7 is a view illustrating a first ball member disposed in the housing. FIG. 8 is a diagram illustrating the reflective module being rotated with the second optical axis as the rotation axis. FIG. 9 is a diagram illustrating the holder being rotated using the first axis as the rotation axis.

The reflective module 300 includes a reflection member 310, a holder 330, and a guide member 320.

The reflective member 310 has a reflective surface reflecting light that has passed through the first lens module 210. For example, the reflecting member 310 may be a prism or mirror.

The reflective member 310 is mounted on the holder 330. A first lens module 210 may be disposed in front of the reflective member 310. In an embodiment, the first lens module 210 may be mounted on the holder 330.

The holder 330 is disposed on the guide member 320 rotatable. Moreover, the guide member 320 is disposed in the housing 100 in a rotatable manner.

The guide member 320 may be rotated using the second optical axis (Z-axis) as a rotation axis. For example, the guide member 320 may be rotated relative to the housing 100 using the second optical axis (Z-axis) as a rotation axis. The first lens module 210 and the holder 330 may also be rotated together with the guide member 320. Meanwhile, the second optical axis (Z-axis) may also be referred to as the first rotation axis.

The holder 330 may be rotated using the first axis (X-axis), which is perpendicular to both the first optical axis (Y-axis) and the second optical axis (Z-axis), as a rotation axis. For example, the holder 330 may be rotated relative to the guide member 320 using the first axis (X-axis) as a rotation axis. The first lens module 210 may be rotated together with the holder 330.

Meanwhile, the first axis (X-axis) may also be referred to as the second rotation axis.

A first driving unit 400 may be provided to rotate the reflective module 300. The first driving unit 400 includes a first magnet 410 and a first coil 420. The guide member 320 may be rotated by the first driving unit 400. As the holder 330 is disposed on the guide member 320 and the first lens module 210 is disposed on the holder 330, the holder 330 and the first lens module 210 may also rotate together with the guide member 320.

The first magnet 410 may be mounted on the guide member 320. As an example, the first magnet 410 may be mounted on one side surface of the guide member 320.

The first magnet 410 may be magnetized so that one side (e.g., the side facing the first coil 420) may have both an N-pole and an S-pole. In an embodiment, one surface of the first magnet 410 facing the first coil 420 may be provided with an N-pole, a neutral region, and an S-pole in order in the first optical axis (Y-axis) direction.

A virtual line extending the second optical axis (Z-axis) of the second lens module 220 may pass through one surface of the first magnet 410. For example, a virtual line extending the second optical axis (Z-axis) of the second lens module 220 may pass through the neutral region of the first magnet 410.

The first coil 420 may be disposed in a position facing the first magnet 410. In an embodiment, the first coil 420 may be arranged to face the first magnet 410 in the second optical axis (Z-axis) direction.

The first coil 420 is disposed on a substrate 900, and the substrate 900 is mounted on the housing 100 so that the first magnet 410 and the first coil 420 face each other in the second optical axis (Z-axis) direction. In an embodiment, the first coil 420 may be disposed on one inner surface of the substrate 900. The substrate 900 may be mounted on the side of the housing 100 so that the first magnet 410 and the first coil 420 face each other in the second optical axis (Z-axis) direction.

The housing 100 is provided with a through-hole penetrating the housing 100, and the first coil 420 is disposed in the through-hole so as to directly face the first magnet 410.

During shake correction, the first magnet 410 is a moving member mounted on the guide member 320 and rotates with the guide member 320, and the first coil 420 is a fixed member fixed to the substrate 900.

The first coil 420 may include two coils. The two coils may be spaced apart in the first axis (X-axis) direction. By applying current to the two coils in opposite directions, the first driver 400 can generate a driving force desired for the rotation of the guide member 320 around the second optical axis (Z-axis).

In another embodiment, the first magnet 410 may include two magnets spaced apart in the first axis (X-axis) direction, and each magnet may be arranged to face one coil.

A first ball member B1 may be disposed between the guide member 320 and the housing 100. The first ball member B1 is disposed between the guide member 320 and the housing 100 to support the rotation of the guide member 320 and may reduce friction when the guide member 320 rotates.

The first ball member B1 may include a first ball group BG1 and a second ball group BG2 spaced apart in the second optical axis (Z-axis) direction.

The first ball group BG1 may include a plurality of balls. The plurality of balls of the first ball group BG1 may be arranged in the first axis (X-axis) direction. The second ball group BG2 may include a plurality of balls. The plurality of balls in the second ball group BG2 may be arranged in the first axis (X-axis) direction. In an embodiment, the second ball group BG2 may include fewer balls than the number of balls included in the first ball group BG1.

The plurality of balls in the first ball group BG1 and the plurality of balls in the second ball group BG2 may roll when the guide member 320 rotates.

Attractive force may act between the guide member 320 and the housing 100. In an embodiment, a first pulling magnet 430 may be disposed on the guide member 320, and a first pulling yoke 440 may be disposed on the housing 100. In another embodiment, it is possible for the first pulling magnet 430 to be disposed on both the guide member 320 and the housing 100.

The first pulling magnet 430 may be disposed between the first ball group BG1 and the second ball group BG2.

One side of the first pulling magnet 430 (e.g., the side facing the first pulling yoke 440) may be in the form of a magnetized N-pole, a neutral region, and an S-pole in the first axis (X axis) direction.

The first pulling magnet 430 and the first pulling yoke 440 may face each other in the first optical axis (Y-axis) direction. In an embodiment, the first pulling magnet 430 may be disposed on the lower surface of the guide member 320, and the first pulling yoke 440 may be disposed on the bottom surface of the housing 100. A through-hole penetrating the bottom surface of the housing 100 may be disposed in the housing 100, and the first pulling yoke 440 may directly face the first pulling magnet 430 through the through-hole.

The first pulling magnet 430 and the first pulling yoke 440 may generate attractive force between each other. For example, the first pulling yoke 440 may be made of a magnetic material. An attractive force acts between the first pulling magnet 430 and the first pulling yoke 440 in the direction of the first optical axis (Y-axis).

The first ball member B1 may be maintained in contact with the guide member 320 and the housing 100 due to the attractive force between the first pulling magnet 430 and the first pulling yoke 440.

The length of the first pulling yoke 440 in the first axis (X-axis) direction may be smaller than the length of the first pulling magnet 430 in the first axis (X-axis) direction.

When viewed in the first optical axis (Y-axis) direction, one end of the first pulling yoke 440 in the first axis (X-axis) direction may be located between the N-pole of the first pulling magnet 430 and the neutral region. Moreover, when viewed in the first optical axis (Y-axis) direction, the other end of the first pulling yoke 440 in the first axis (X-axis) direction may be located between the S-pole of the first pulling magnet 430 and the neutral region.

In the surfaces where the guide member 320 and the housing 100 face each other (e.g., the surfaces facing in the first optical axis (Y-axis) direction), a first guide groove g1 and a second guide groove g2 are disposed, respectively. For example, a first guide groove g1 and a second guide groove g2 are formed in the lower surface of the guide member 320, and the first guide groove g1 and the second guide groove g2 may be formed in the inner bottom surface of the housing 100.

The first guide groove g1 and the second guide groove g2 may each have a rounded shape. In an embodiment, the first guide groove g1 and the second guide groove g2 each have a rolling surface or channel on which balls roll, and the rolling surface may be a curved surface.

In an embodiment, the radius of curvature of the cloud surface may be equal to the distance between the second optical axis (Z-axis) (or a virtual axis extending the second optical axis (Z-axis)) and the cloud surface.

In an embodiment, the rolling surface or channel of the first guide groove g1 and the rolling surface or channel of the second guide groove g2 may be an arc of a circle centered on the second optical axis (Z-axis), which is the axis of rotation (or an imaginary axis extending the second optical axis (Z-axis)).

Accordingly, the guide member 320 can be rotated using the second optical axis (Z-axis) as the rotation axis.

The first guide groove g1 and the second guide groove g2 may be spaced apart in the second optical axis (Z-axis) direction.

A first ball group BG1 is disposed in the first guide groove g1, and a second ball group BG2 is disposed in the second guide groove g2.

In an embodiment, the first ball group BG1 and the second ball group BG2 each include three balls. The three balls of the first ball group BG1 are arranged along the first axis (X-axis) direction. The three balls of the second ball group BG2 are also arranged in the first axis (X-axis) direction.

Among the three balls of the first ball group (BG1), the two balls disposed outermost in the first axis (X-axis) direction have a larger diameter than the balls disposed therebetween. Moreover, among the three balls of the first ball group (BG1), the two balls disposed outermost in the first axis (X-axis) direction are in two-point contact with the first guide groove g1 of the guide member 320 and two-point contact with the first guide groove g1 of the housing 100. Among the three balls of the first ball group BG1, the ball with a smaller diameter contacts the first guide groove g1 of the guide member 320 or the first guide groove g1 of the housing 100.

Among the three balls of the second ball group BG2, the two balls disposed outermost in the first axis (X-axis) direction have a larger diameter than the balls disposed therebetween. Moreover, among the three balls of the second ball group BG2, the two balls disposed outermost side in the first axis (X-axis) direction, are in two-point contact with the second guide groove g2 of the guide member 320 and make one point of contact with the second guide groove g2 of the housing 100 (and vice versa). The ball having a smaller diameter of the three balls of the second ball group BG2 is contacted by the second guide groove g2 of the guide member 320 or the second guide groove g2 of the housing 100.

The first ball group BG1 and the first guide groove g1 may function as the main guide to guide the rotation of the guide member 320, and the second ball group BG2 and the second guide groove g2 may function as a secondary guide supporting the rotation of the guide member 320.

In another embodiment, the first ball group BG1 includes three balls, and the second ball group BG2 includes fewer balls than the first ball group BG1. That is, the second ball group BG2 may include one or two balls.

In an embodiment, the camera module 1 may detect the position of the guide member 320. To this end, the first location sensor 450 is provided. The first position sensor 450 may be disposed in the position facing the first pulling magnet 430 of the guide member 320 (e.g., the position facing the first optical axis (Y-axis) direction). For example, in the housing 100, a through-hole that penetrates the housing 100 in the direction of the first optical axis (Y-axis) may be disposed, and the first position sensor 450 may be disposed in the through-hole. The first position sensor 450 is connected to the substrate 900. In an embodiment, a substrate 900 covering the through-hole may be disposed on the lower surface of the housing 100, and the first position sensor 450 may be disposed on the substrate 900.

Therefore, when the guide member 320 is rotated with the second optical axis as a rotation axis, the position of the guide member 320 may be detected through the first position sensor 450.

In another embodiment, the first position sensor 450 may be disposed in the position facing the first magnet 410 (e.g., the position facing the second light axis (Z-axis)).

The first location sensor 450 may be a hall sensor.

The second driving unit 500 may be provided to rotate the holder 330. The second driver 500 includes a second magnet 510 and a second coil 520. The holder 330 may be rotated relative to the guide member 320 by the second driving unit 500. Since the first lens module 210 is disposed in the holder 330, the first lens module 210 may be rotated with the holder 330.

The second magnet 510 may be mounted on the holder 330. The second magnet 510 may be mounted on the side surface of the holder 330. In an embodiment, the second magnet 510 may include two magnets, and one magnet may be mounted on one side surface and the other side surface of the holder 330. One side of the holder 330 and the other side of the holder 330 may be spaced apart in the first axis (X-axis) direction.

The first ball member B1 may be disposed between the two magnets of the second magnet 510.

The second magnet 510 may be compiled one surface (e.g., the surface facing the second coil 520) to have both N and S-poles. In an embodiment, one surface of the second magnet 510 facing the second coil 520 may be provided with an N-pole, neutral region and S-pole according to the first optical axis (Y-axis) direction.

The second coil 520 may be disposed in a position facing the second magnet 510. In an embodiment, the second coil 520 may be disposed to face the second magnet 510 in the first axis (X-axis) direction.

The second coil 520 is disposed on the substrate 900, and the substrate 900 is mounted on the housing 100 so that the second magnet 510 and the second coil 520 face the first axis (X-axis). In an embodiment, the second coil 520 may be disposed on the other side of the substrate 900. The substrate 900 may be mounted on the side of the housing 100 so that the second magnet 510 and the second coil 520 face the first axis (X-axis) direction.

The housing 100 is provided with a through-hole that penetrates the housing 100, and the second coil 520 is disposed in the through-hole and may face the second magnet 510 directly.

When shaking correction, the second magnet 510 is a moving member mounted on the holder 330 and rotates with the holder 330 and the second coil 520 is a fixed member fixed to the substrate 900.

In an embodiment, the second coil 520 may include two coils. Two coils may be separated in the first axis (X-axis) direction.

The second magnet 510 and the second coil 520 may be separated from the second ball member B2 in the direction of the second optical axis (Z-axis) direction. For example, the second magnet 510 and the second coil 520 may be arranged closer to the first driving unit 400 than the second ball member B2 in the second optical axis (Z-axis) direction.

In an embodiment, the second magnet 510 and the second coil 520 may be disposed between the first driving unit 400 and the second ball member B2 in the second optical axis (Z-axis) direction.

When the power is applied to the second drive unit 500, the second driving unit 500 may generate the driving force desired for the rotation of the first axis (X-axis) of the holder 330 as a rotation axis.

The second ball member B2 may be disposed between the holder 330 and the guide member 320. The second ball member B2 may be disposed between the holder 330 and the guide member 320 to form a rotating shaft of the holder 330.

The second ball member B2 includes a plurality of balls spaced apart from the first axis (X-axis) direction. The virtual line of the plurality of balls of the second ball member B2 in the direction of the first axis (X-axis) may pass through the reflective surface of the reflection member 310.

An attractive force may act between the holder 330 and the guide member 320. In one embodiment, a second pulling magnet 530 may be disposed on the guide member 320, and a second pulling yoke 540 may be disposed on the holder 330. In another embodiment, it is possible for the second pulling magnet 530 to be disposed on both the holder 330 and the guide member 320.

The second pulling magnet 530 may be disposed between the pluralities of balls of the second ball member B2.

One surface of the second pulling magnet 530 (e.g., the surface facing the second pulling yoke 540) may be magnetized in the form of an N-pole, neutral region, and S-pole in the second optical axis (Z-axis) direction.

The second pulling magnet 530 and the second pulling yoke 540 may face each other in the first optical axis (Y-axis) direction. In an embodiment, the second pulling magnet 530 may be disposed on the upper surface of the guide member 320, and the second pulling yoke 540 may be disposed on the lower surface of the holder 330.

The second pulling magnet 530 and the second pulling yoke 540 may generate attractive force between each other. For example, the second pulling yoke 540 may be made of a magnetic material. An attractive force acts between the second pulling magnet 530 and the second pulling yoke 540 in the direction of the first optical axis (Y-axis).

The second ball member B2 may be maintained in contact with the holder 330 and the guide member 320 due to the attractive force between the second pulling magnet 530 and the second pulling yoke 540.

Meanwhile, the length of the second pulling yoke 540 in the second optical axis (Z-axis) direction may be smaller than the length of the second pulling magnet 530 in the second optical axis (Z-axis) direction.

When viewed in the first optical axis (Y-axis) direction, one end of the second pulling yoke 540 in the second optical axis (Z-axis) direction may be located between the N-pole and the neutral region of the second pulling magnet 530. Moreover, when viewed in the first optical axis (Y-axis) direction, the other end of the second pulling yoke 540 in the second optical axis (Z-axis) direction may be located between the S-pole and the neutral region of the second pulling magnet 530.

A third guide groove g3 may be disposed on a surface (e.g., a surface facing in the first optical axis (Y-axis) direction) where the holder 330 and the guide member 320 face each other. The third guide groove g3 includes a plurality of grooves spaced apart in the first axis (X-axis) direction.

The second ball member B2 may be accommodated in the third guide groove g3 to form the rotation axis of the holder 330.

In an embodiment, the camera module 1 can detect the position of the holder 330. For this purpose, a second position sensor 550 is provided. The second position sensor 550 may be disposed at a position facing the second magnet 510 of the second driving unit 500 (e.g., a position facing the first axis (X-axis) direction).

Therefore, when the holder 330 is rotated around the first axis (X-axis) as the rotation axis, the position of the holder 330 can be detected through the second position sensor 550.

The second position sensor 550 may be a hall sensor.

Meanwhile, referring to FIG. 5, a spacer 211 may be disposed on the lower surface of the first lens module 210 (e.g., the surface facing the reflective member 310). The spacer 211 has an entrance hole through which light passes, and the entrance hole may be non-circular. For example, the entrance hole may be shaped like a running track. That is, an inner surface of the spacer 211 forming the entrance hole may include two planes extending parallel to each other and two curved surfaces connecting the two planes.

The inner surface of the spacer 211 may have a waveform in which concave and convex shapes are repeated, thereby preventing the flare phenomenon.

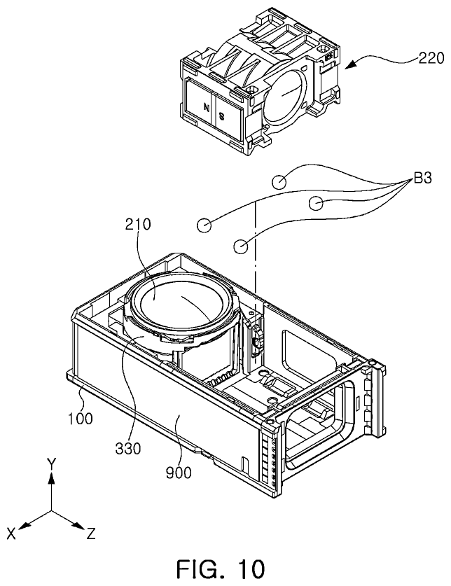

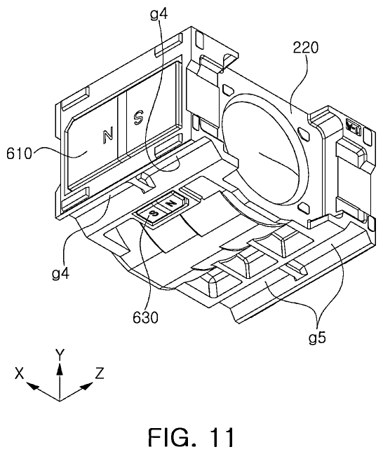

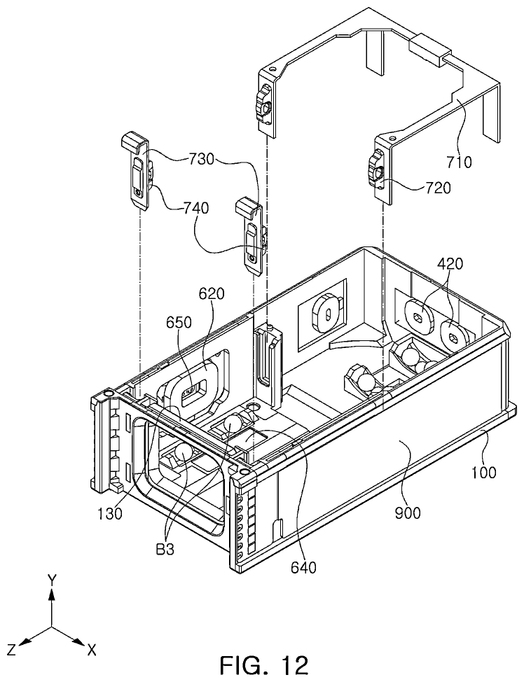

FIG. 10 is a perspective view illustrating the second lens module separated from the camera module according to an embodiment of the present disclosure, FIG. 11 is a bottom perspective view of the second lens module, and FIG. 12 is a diagram illustrating the first stopper and the second stopper being coupled to the housing.

Referring to FIG. 10, a second lens module 220 may be disposed between the reflective module 300 and the image sensor module 800.

The second lens module 220 may be moved in the second optical axis (Z-axis) direction for focus adjustment.

The camera module 1 may include a third driving unit 600 to move the second lens module 220 in the second optical axis (Z-axis) direction.

The third driving unit 600 includes a third magnet 610 and a third coil 620. The third magnet 610 and the third coil 620 may be arranged to face each other in a direction perpendicular to the second optical axis (Z-axis) direction.

The third magnet 610 is mounted on the second lens module 220. As an example, the third magnet 610 may be disposed on one surface of the second lens module 220. That is, the second lens module 220 has one side and the other side spaced apart in the first axis (X-axis) direction, and the third magnet 610 may be disposed on one side of the second lens module 220.

The third magnet 610 may be magnetized so that one surface (e.g., the side facing the third coil 620 may have both an N-pole and an S-pole. For example, one surface of the third magnet 610 facing the third coil 620 may sequentially include an N-pole, a neutral region, and an S-pole in the second optical axis (Z-axis) direction.

The third coil 620 is arranged to face the third magnet 610. For example, the third coil 620 may be arranged to face the third magnet 610 in a direction perpendicular to the second optical axis (Z-axis) direction (e.g., in the first axis (X-axis) direction).

The third coil 620 is disposed on the substrate 900, and the substrate 900 is mounted on the housing 100 so that the third magnet 610 and the third coil 620 face each other in the first axis (X-axis) direction.

The housing 100 is provided with a through-hole penetrating the housing 100, and the third coil 620 disposed on the substrate 900 can directly face the third magnet 610 through the through-hole.

During focus adjustment, the third magnet 610 is a moving member that is mounted on the second lens module 220 and moves in the direction of the second optical axis (Z-axis) together with the second lens module 220, and the third coil 620 is a fixing member fixed to the substrate 900.

When power is applied to the third coil 620, the second lens module 220 can be moved in the second optical axis (Z-axis) direction by the electromagnetic force between the third magnet 610 and the third coil 620.

A third ball member B3 is disposed between the second lens module 220 and the housing 100, and the second lens module 220 may be guided by the third ball member B3 and moved in the direction of the second optical axis (Z-axis). The third ball member B3 includes a plurality of balls.

A third pulling magnet 630 may be disposed on the lower surface of the second lens module 220, and a third pulling yoke 640 may be disposed on the inner bottom surface of the housing 100. In another embodiment, it is possible for the third pulling magnet 630 to be disposed on both the second lens module 220 and the housing 100.

The third pulling magnet 630 may be disposed closer to one side surface of the second lens module 220. That is, the third pulling magnet 630 may be disposed closer to the side surface of the second lens module 220 where the third magnet 610 is mounted, than to the other side of the second lens module 220 where the third magnet 610 is not mounted. Additionally, the third pulling magnet 630 may be disposed between one side surface of the second lens module 220 and the second optical axis (Z-axis).

The third pulling yoke 640 may be disposed at a position facing the third pulling magnet 630 in the first optical axis (Y-axis) direction. The third pulling magnet 630 and the third pulling yoke 640 may generate attractive force between each other. For example, an attractive force acts between the third pulling magnet 630 and the third pulling yoke 640 in the direction of the first optical axis (Y-axis).

The third ball member B3 may be in contact with the second lens module 220 and the housing 100, respectively, due to the attractive force of the third pulling magnet 630 and the third pulling yoke 640.

A fourth guide groove g4 and a fifth guide groove g5 may be disposed on surfaces where the second lens module 220 and the housing 100 face each other. For example, a fourth guide groove g4 is disposed on one side of the surfaces where the second lens module 220 and the housing 100 face each other, and the fifth guide groove g5 may be disposed on the other sides of surfaces where the second lens module 220 and the housing 100 face each other.

The fourth guide groove g4 and the fifth guide groove g5 may be spaced apart in a direction perpendicular to the second optical axis (Z-axis) direction (e.g., the first axis (X-axis) direction).

The fourth guide groove g4 and the fifth guide groove g5 extend in a direction parallel to the second optical axis (Z-axis).

Some of the plurality of balls of the third ball member B3 are disposed in the fourth guide groove g4, and the rest of the plurality of balls of the third ball member B3 are disposed in the fifth guide groove g5.

The number of contact points between some of the plurality of balls of the third ball member B3 and the fourth guide groove g4 is greater than the number of contact points between the rest of the plurality of balls of the third ball member B3 and the fifth guide groove g5.

The fourth guide groove g4 may be disposed closer to the third magnet 610 than the fifth guide groove g5.

The third pulling magnet 630 may be disposed closer to the fourth guide groove g4 than the fifth guide groove g5.

In an embodiment, the camera module 1 may detect the position of the second lens module 220. For this purpose, a third position sensor 650 is provided. The third position sensor 650 may be disposed at a position facing the third magnet 610 of the third driving unit 600 (e.g., a position facing the first axis (X-axis)).

Accordingly, when the second lens module 220 moves in the second optical axis (Z-axis) direction, the position of the second lens module 220 can be detected through the third position sensor 650.

The third position sensor 650 may be a hall sensor.

Meanwhile, referring to FIG. 12, the camera module 1 may further include a first stopper 710. The first stopper 710 may be coupled to the housing 100 to cover at least a portion of the reflective module 300. For example, the first stopper 710 may cover at least a portion of the upper surface of the holder 330.

The first stopper 710 can prevent the reflective module 300 from being separated from the housing 100 due to external impact, etc. A buffer member 720 having elastic force may be coupled to the first stopper 710. For example, the first stopper 710 has a surface that faces the second lens module 220 in the direction of the second optical axis (Z-axis), and the buffer member 720 can be mounted on that surface.

The camera module 1 may further include a second stopper 730. The second stopper 730 may be coupled to the housing 100 and may be disposed in the space between the second lens module 220 and the image sensor module 800. For example, the second stopper 730 may be disposed on both sides of the light-blocking plate 130.

A buffer member 740 having elastic force may be coupled to the second stopper 730. For example, the second stopper 740 may have a surface that faces the second lens module 220 in the second optical axis (Z-axis) direction, and the buffer member 740 may be mounted on the corresponding surface.

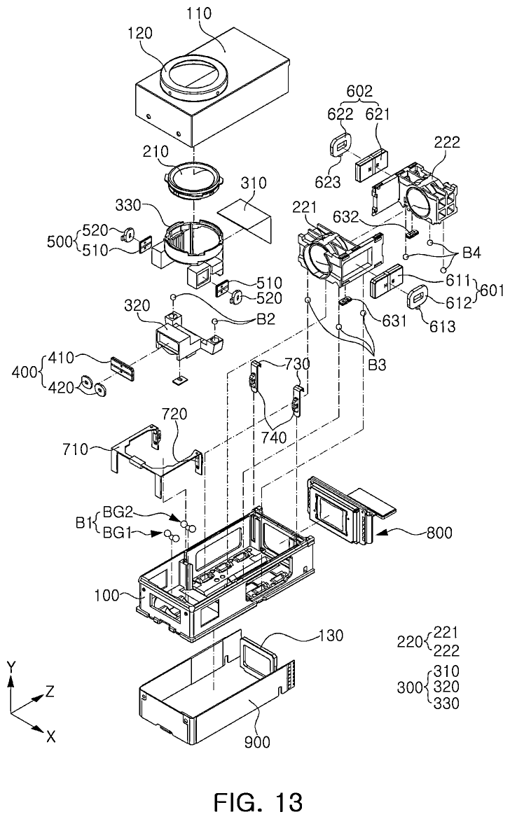

FIG. 13 is an exploded perspective view of a camera module according to another embodiment of the present disclosure.

The camera module of the embodiment illustrated in FIG. 13 includes a second lens module 221, and a third lens module 222.

The second lens module 221 and the third lens module 222 each include a plurality of lenses, which are arranged along the second optical axis (Z-axis).

The second lens module 221 and the third lens module 222 each have an extension portion extending in the second optical axis (Z-axis) direction.

The second lens module 221 has one side surface and another side surface that is spaced apart in the first axis (X-axis) direction, and the extension of the second lens module 221 may be extended in one side surface of the second lens module 221 in the second optical axis (Z axis).

The third lens module 222 has one side surface and another side surface that is spaced apart in the first axis (X-axis) direction, and the extension of the third lens module 222 may be extended in the direction of the second optical axis (Z axis) from the other side surface of the third lens module 222.

For example, the extension of the second lens module 221 and the extension of the third lens module 222 may be disposed to overlap in the first axis (X-axis) direction.

In an embodiment, at least a portion of the extension of the second lens module 221 and at least a portion of the extension of the third lens module (222) can face each other in the first axis (X-axis) direction.

The second lens module 221 may be able to move in the second optical axis (Z-axis) direction. In an embodiment, the camera module may include a third driving unit 601.

The third driver 601 includes a third magnet 611 and a third coil 612. The third magnet 611 and the third coil 612 may be disposed facing the first axis (X-axis).

The third magnet 611 is mounted on the second lens module 221. For example, the third magnet 611 may be disposed on one side surface of the second lens module 221. At least a portion of the third magnet 611 may be disposed in the extension of the second lens module 221.

The third magnet 611 may be magnetized such that one surface (e.g., the surface facing the third coil 621) has both an N-pole and an S-pole. For example, on one surface of the third magnet 611 facing the third coil 621, may sequentially include an N-poles, a neutral region and an S-poles may be provided in the direction of the second optical axis (Z axis).

The third coil 621 is arranged to face the third magnet 611. The third coil 621 is disposed on the substrate 900, and the substrate 900 is mounted on the housing 100 such that the third magnet 611 and the third coil 621 face each other in the first axis (X-axis) direction.

The housing 100 is provided with a through-hole that penetrates the housing 100, and the third coil 621 disposed on the substrate 900 may face the third magnet 611 directly through the through-hole.

When power is applied to the third coil 621, the electromagnetic force between the third magnet 611 and the third coil 621 may move the second lens module 221 in the second optical axis (Z-axis) direction.

The third ball member B3 is disposed between the second lens module 221 and the housing 100, and the second lens module 221 may be guided by the third ball member B3 to move in the second optical axis (Z-axis) direction.

The third ball member B3 includes three balls. The three balls may be configured to form a triangle with three ball connecting.

Two of the three balls are separated in the direction of the second optical axis (Z-axis) and may be arranged closer to one side surface than the other side surface of the second lens module 221.

The remaining one of the three balls can be disposed closer to the other side surface than the one side surface of the second lens module 221.

A third pulling magnet 631 may be disposed on the lower surface of the second lens module 221, and a third pulling yoke may be disposed on the inner bottom surface of the housing 100. Another embodiment may be able to arrange the third pulling magnet 631 in both the second lens module 221 and the housing 100.

The third pulling magnet 631 may be arranged closer to one side surface than the other side surface of the second lens module 221.

That is, the third pulling magnet 631 may be positioned closer to one side surface of the second lens module 221 where the third magnet 611 is mounted, than to the other side surface of the second lens module 221 where the third magnet 611 is not mounted.

The third pulling magnet 631 may be disposed between one side surface of the second lens module 221 and the second optical axis (Z-axis).

Two of the three balls of the third ball member B3 may be disposed in the space between the third pulling magnet 631 and the one side surface of the second lens module 221.

The third pulling yoke may be disposed in the position facing the third pulling magnet 631 and the first optical axis (Y-axis). The third pulling magnet 631 and the third pulling yoke may generate attraction force between each other.

A plurality of guide grooves may be disposed on the surface where the second lens module 221 and the housing 100 face each other. The three balls of the third ball member B3 are disposed in a plurality of guide grooves.

Some of the plurality of guide grooves may be extended to the lower surface of the extension of the second lens module 221. In addition, one of the two balls of the third ball member B3 positioned closer to one side surface of the second lens module 221 may be located between the extension of the second lens module 221 and the housing 100.

Two balls located close to one side of the second lens module 221 in the third ball member B3 each have a two-point contact with the guide groove of the second lens module 221, respectively, and a two-point contact with the guide groove of the housing 100.

A ball arranged close to the other side surface of the second lens module 221 in the third ball member B3 contacts two points in contact with the guide groove of the second lens module 221, and one point in contact with the guide groove of the housing 100 (and vice versa).

In an embodiment, the camera module may detect the position of the second lens module 221. To this end, a third location sensor 613 is provided. The third location sensor 613 may be disposed in the position facing the third magnet 611 (e.g., the position facing the first axis (X-axis)).

Therefore, when the second lens module 221 is moved in the direction of the second optical axis (Z-axis), the position of the second lens module 221 may be detected via the third position sensor 613. The third location sensor 613 may be a hall sensor.

The third lens module 222 may be able to move in the second optical axis (Z axis) direction. In an embodiment, the camera module may include a fourth driving unit 602.

The fourth driver 602 includes the fourth magnet 621 and the fourth coil 622. The fourth magnet 621 and the fourth coil 622 may be disposed facing in the first axis (X-axis) direction.

The fourth magnet 621 is mounted on the third lens module 222. For example, the fourth magnet 621 may be disposed on the other side surface of the third lens module 222. And at least a portion of the fourth magnet 621 may be disposed in the extension of the third lens module 222.

The fourth magnet 621 may be magnetized such that one surface (e.g., the surface facing the fourth coil 622) has both an N-pole and an S-pole. For example, one surface of the fourth magnet 621 facing the fourth coil 622 may be provided with an N-pole, a neutral region and an S-poles in sequence in the direction of the second optical axis (Z-axis).

The fourth coil 622 is arranged to face the fourth magnet 621. The fourth coil 622 is disposed on the substrate 900, and the substrate 900 is mounted on the housing 100 such that the fourth magnet 621 and the fourth coil 622 face each other in the first axis (X-axis) direction.

The housing 100 is provided with a through-hole that penetrates the housing 100, and the fourth coil 622 disposed on the substrate 900 may face the fourth magnet 621 directly through the through-hole.

When the power is applied to the fourth coil 622, the electromagnetic force between the fourth magnet 621 and the fourth coil 622 may move the third lens module 222 in the second optical axis (Z-axis) direction.

The fourth ball member B4 is disposed between the third lens module 222 and the housing 100, and the four-ball member B4 is disposed, and the third lens module 222 may be guided by the fourth ball member B4 to move in the second optical axis (Z-axis) direction. The fourth ball member (B4) includes three balls. The three balls can be configured to form a triangle with three ball connections.

Two of the three balls are separated in the direction of the second optical axis (Z-axis) and may be arranged closer to the other side surface than one side surface of the third lens module 222.

The remaining one of the three balls may be disposed closer to one side surface than the other side surface of the third lens module 222.

The fourth pulling magnet 632 may be disposed on the lower surface of the third lens module 222, and a fourth pulling yoke may be disposed on the inside bottom surface of the housing 100. In another embodiment, the fourth pulling magnet 632 may be disposed in both the third lens module 222 and the housing 100.

The fourth pulling magnet 632 may be disposed closer to the other side surface than the one side surface of the third lens module 222. That is, the fourth pulling magnet 632 may be disposed closer to the other side surface of the third lens module 222 where the fourth magnet 621 is mounted, than to one side surface of the third lens module 222 where the fourth magnet 621 is not mounted.

The fourth pulling magnet 632 may be disposed between the other side surface of the third lens module 222 and the second optical axis (Z-axis) direction.

Two of the three balls of the fourth ball member B4 may be disposed in the space between the fourth pooling magnet 632 and the other side surface of the third lens module 222.

The fourth pulling yoke may be disposed in the position facing the fourth pulling magnet 632 and the first optical axis (Y-axis) direction. The fourth pulling magnet 632 and the fourth pulling yoke may generate attractive force between each other.

A plurality of guide grooves may be disposed on the surface where the third lens module 222 and the housing 100 face each other. The three balls of the fourth ball member B4 are disposed in a plurality of guide grooves.

Some of the plurality of guide grooves may be extended to the lower surface of the extension of the third lens module 222. In addition, one of the two balls arranged close to the other side surface of the third lens module 222 in the fourth ball member B4 will be located between the extension of the third lens module 222 and the housing 100.

Two balls of the fourth ball member B4 disposed closer to the other side surface of the third lens module 222, each contact with two-points of the guide groove of the third lens module 222, and two-points contact with the guide groove of the housing 100.

A ball of the fourth ball member (B4) disposed closer to one side surface of the third lens module (222) makes contact with two-points of the guide groove of the third lens module 222 and one-point contact with the guide groove of the housing 100 (and vice versa).

In an embodiment, the camera module may detect the position of the third lens module 222. To this end, the fourth position sensor 623 is provided. The fourth location sensor 623 may be disposed at the location facing the fourth magnet 621 (e.g., the position facing the first axis (X-axis)).

Therefore, when the third lens module 222 is moved in the direction of the second optical axis (Z-axis), the position of the third lens module 222 may be detected through the fourth position sensor 623. The fourth position sensor 623 may be a hall sensor.

An aspect of the present disclosure is to provide a reflective module that can prevent resolution deterioration during shake correction and a camera module comprising the same.

According to another aspect of the present disclosure, the reflective module and a camera module comprising the same may prevent resolution deterioration during the shake correction.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A reflective module comprising:
a first lens module having a first optical axis;
a holder on which a reflective member is disposed to reflect light passing through the first lens module;
a guide member on which the holder is disposed;
a housing accommodating the holder and the guide member; and
a first ball member, disposed between the guide member and the housing, comprising a first ball group and a second ball group, spaced apart in a direction of a first rotation axis,
wherein the first lens module and the holder are configured to rotate together about the first rotation axis and a second rotation axis, perpendicular to each other and perpendicular to the first optical axis,
wherein the guide member is configured to rotate about the first rotation axis, together with the first lens module and the holder, and
wherein the first ball group includes a plurality of balls arranged in a direction of the second rotation axis.

2. The reflective module of claim 1, wherein a first guide groove and a second guide groove are disposed on surfaces on which the guide member and the housing face each other in a direction of the first optical axis,
wherein the first ball group is disposed in the first guide groove, and the second ball group is disposed in the second guide groove, and
wherein each of the first guide groove and the second guide groove has a curved profile.

3. The reflective module of claim 2, wherein each of the first guide groove and the second guide groove has a rolling channel for the first ball group or the second ball group, and
a radius of curvature of the rolling channel is equal to a distance in the direction of the first optical axis between the first rotation axis and the rolling channel.

4. The reflective module of claim 1, wherein, among a plurality of balls in the first ball group, two balls disposed outermost in the direction of the second rotation axis have a larger diameter than a ball disposed therebetween.

5. The reflective module of claim 4, wherein the two balls are in two-point contact with the guide member, and are in two-point contact with the housing.

6. The reflective module of claim 4, wherein the second ball group comprises a fewer number of balls than the plurality of balls included in the first ball group.

7. The reflective module of claim 1, wherein a diameter of an intermediate ball of the first ball group is smaller than diameters of other balls of the first ball group.

8. The reflective module of claim 1, wherein a first pulling magnet is disposed on one of the guide member or the housing, and a first pulling yoke is disposed on another thereof,
wherein the first pulling magnet and the first pulling yoke face each other in the direction of the first optical axis, and
wherein the first pulling magnet is disposed between the first ball group and the second ball group.

9. The reflective module of claim 1, further comprising a first driving unit comprising a first magnet disposed on the guide member, and a first coil disposed to face the first magnet,
wherein the first magnet and the first coil face each other in the direction of the first rotation axis, and
wherein one surface of the first magnet facing the first coil has an N-pole, a neutral region, and an S-pole along the first optical axis.

10. The reflective module of claim 9, wherein a virtual line extending the first rotation axis passes through the one surface of the first magnet.

11. The reflective module of claim 9, wherein the first coil comprises two coils spaced apart in the direction of the second rotation axis.

12. The reflective module of claim 1, further comprising a second ball member disposed between the holder and the guide member,
wherein the second ball member comprises a plurality of balls spaced apart in the direction of the second rotation axis.

13. The reflective module of claim 12, wherein a second pulling magnet is disposed on one of the holder or the guide member, and a second pulling yoke is disposed on another thereof,
wherein the second pulling magnet and the second pulling yoke face each other in the direction of the first optical axis, and
wherein the second pulling magnet is disposed between the plurality of balls of the second ball member.

14. The reflective module of claim 12, further comprising a second driving unit comprising a second magnet disposed in the holder and a second coil disposed to face the second magnet,
wherein one surface of the second magnet facing the second coil has an N-pole, a neutral region, and an S-pole along the first optical axis, and
wherein the second driving unit is disposed to be spaced apart from the second ball member in a direction of the first rotation axis.

15. A camera module comprising the reflective module of claim 1.

16. A camera module comprising:
a guide member disposed in a housing to rotate about a first rotation axis;
a holder disposed on the guide member to rotate relative to the guide member, based on a second rotation axis, perpendicular to the first rotation axis, and having a reflective member;
a first ball member, disposed between the guide member and the housing, comprising a plurality of balls arranged to roll in a direction of the second rotation axis;
a first lens module mounted on the holder and having a first optical axis, perpendicular to both the first and second rotation axes; and
a second lens module into which light reflected from the reflective member is incident.

17. The camera module of claim 16, wherein a guide groove is disposed on surfaces on which the guide member and the housing face each other in a direction of the first optical axis, and
wherein the guide groove has a curved profile around the first rotation axis.

18. The camera module of claim 16, further comprising:
a first driving unit comprising a first magnet disposed on the guide member, and a first coil disposed to face the first magnet in a direction of the first rotation axis;
a second driving unit comprising a second magnet disposed in the holder and a second coil disposed to face the second magnet; and
a second ball member, disposed between the holder and the guide member, comprising a plurality of balls spaced apart in the direction of the second rotation axis.

19. The camera module of claim 18, wherein the second driving unit is disposed between the first driving unit and the second ball member in the direction of the first rotation axis,
wherein the second driving unit comprises two magnets spaced apart in the direction of the second rotation axis and two coils spaced apart in the direction of the second rotation axis, and
wherein the first ball member is disposed between the two magnets.
